(19) United States
(12) Patent Application Publication
(10) Pub. No.: US 2009/0301298 A1
(43) Pub. Date: Dec. 10, 2009

(54) Apparatus for Treating a Gas Stream

(76) Inventor: Andrew James Seeley, Bristol (GB)

Correspondence Address: Edwards Vacuum, Inc., 2041 MISSION COLLEGE BOULEVARD, SUITE 260, SANTA CLARA, CA, 95054, US

(21) Appl. No.: 12/084,193

(22) PCT Filed: Oct. 5, 2006
(86) PCT No.: PCT/GB2006/003704

§ 371 Date: Jul. 2, 2009

(30) Foreign Application Priority Data
Oct. 26, 2005 (GB) 0521842.5

(51) Int. Cl. B03C 3/017; B03C 3/00

(52) U.S. Cl. 95/58; 96/52

(57) ABSTRACT

Apparatus for treating a gas stream comprises a plasma abatement device (10). A wet electrostatic precipitator (20,22) is provided upstream from the abatement device (10) to remove particulates from the gas stream to inhibit clogging on the inlet of the abatement device. An additional wet electrostatic precipitator (24) may be provided downstream from the abatement device (10) for removing from the gas stream particulates generated within the abatement device (10).

The present invention relates to apparatus for treating a gas stream. The invention finds particular application in the treatment of a gas stream exhaust from a process chamber used in the semiconductor or flat panel display industry.

A primary step in the fabrication of semiconductor devices is the formation of a thin film on a semiconductor substrate by chemical reaction of vapour precursors. One known technique for depositing a thin film on a substrate is chemical vapour deposition (CVD), which is commonly plasma enhanced. In this technique, process gases are supplied to a process chamber housing the substrate and react to form a thin film over the surface of the substrate. Examples of gases supplied to the process chamber to form a thin film include, but are not restricted to:
Silane and ammonia for the formation of a silicon nitride film;
Silane, ammonia and nitrous oxide for the formation of a SiON film;
TEOS and one of oxygen and ozone for the formation of a silicon oxide film; and
Al(CH₃)₃ and water vapour for the formation of an aluminium oxide film.

In the deposition process, the conditions immediate to the substrate are optimised to minimise gas-phase reactions and maximise surface reactions for the formation of a continuous film on the substrate. However, conditions elsewhere in the chamber and downstream from the chamber are not so optimised, and gas-phase nucleation can result in the formation of particulates. These particulates are generally formed with a range of sizes, from a few microns in diameter up to a few tens or hundreds of microns in diameter, and finer particulates can tend to agglomerate to form larger particulates.

Particulates generated within the chamber can fall on the substrate and cause a defect in the deposited thin film, or interfere with the mechanical operation of the deposition system. As a result of this, the inside surface of the process chamber is regularly cleaned to remove the unwanted particulates from the chamber. One method of cleaning the chamber is to supply a perfluorocompound cleaning gas such as NF₃ or C₂F₆ which, when plasma activated, react with the unwanted particulates.

Following the deposition or cleaning process conducted within the process chamber, there is typically a residual amount of the gas supplied to the process chamber contained in the gas exhaust from the process chamber. Process gases such as silane and ammonia highly dangerous if exhausted to the atmosphere, and cleaning gases such as perfluorocompounds are greenhouse gases. In view of this, before the exhaust gas is vented to the atmosphere, abatement apparatus is often provided to treat the exhaust gas to convert the more hazardous components of the exhaust gas into species that can be readily removed from the exhaust gas, for example by conventional scrubbing, and/or can be safely exhausted to the atmosphere.

The presence of particulates within the gas stream conveyed from the process chamber to the abatement apparatus can lead to clogging of the inlet of the abatement apparatus. Therefore, it is desirable to remove particulates from the gas stream upstream from the abatement apparatus. For example, U.S. Pat. No. 6,333,010 describes a gas stream treatment system in which a pre-treatment unit is provided upstream from an oxidising unit for oxidising components of the gas stream. The oxidising unit is provided by a heated tube or electrically fired heater, into which air or another oxidant is supplied for reacting with the oxidisable components of the gas stream. The pre-treatment unit is provided by a wet scrubbing system such as a wet cyclone, wet packed tower or wet spray tower.

Such a pre-treatment unit would be able to remove larger particulates from the gas stream, which generally provide between 30-50% of the particulates contained within a gas stream output from a semiconductor process chamber. However, the remaining, smaller particulates would remain in the gas stream; the smaller particulates would not be removed by a wet scrubbing system, whereas agglomerations of smaller particulates would be broken up within the scrubbing system. This is generally not a problem when the oxidising unit is provided by a heated tube or electrically fired heater, which typically have inlets of around 10 to 25 mm in diameter.

Current trends are to move towards fuel-free abatement techniques. Gases exhausted from an etch process chamber can be removed from the gas stream with high efficiency and at a relatively low cost using a plasma abatement device. In the plasma abatement process, the gas stream is caused to flow into a high density plasma and under the intensive conditions within the plasma species within the gas stream are subjected to impact with energetic electrons causing dissociation into reactive species which can combine with oxygen or hydrogen to produce relatively stable by-products. For example, C₂F₆ can be converted into CO, CO₂ and HF, which can be removed in a further treatment step. It is therefore desirable to extend plasma abatement techniques to gases exhaust from a CVD process chamber for, for example, the conversion of SiH₄ into SiO₂, so that a single fuel-free abatement technique can be used to treat gases exhaust from a range of processing chambers.

In order to optimise the destruction efficiency of plasma abatement devices, the inlet to the device is typically of the order of 1 mm². Consequently, the presence in a gas stream exhaust from a CVD process chamber of particulates of only a few microns in diameter can lead to clogging of the inlet of the plasma abatement device. Therefore, pre-treatment units such as those described in U.S. Pat. No. 6,333,010 would be unsuitable for use with such an abatement device. Whilst the plasma abatement device may be configured such that a substantial amount of the finer particulates pass through the abatement device without adhering to the inlet of the abatement device or to the internal surfaces of the abatement device, geometric and electrical constraints of the abatement device may make this difficult to achieve without compromising the efficiency of the abatement device. Therefore, it is desirable to remove the finer particulates from the gas stream upstream from the abatement device.

In a first aspect, the present invention provides apparatus for treating a gas stream, comprising a plasma abatement device having an inlet for receiving the gas stream and, upstream therefrom, an electrostatic precipitator for removing particulates from the gas stream to inhibit clogging of the inlet of the abatement device.

By use of an electrostatic precipitator, preferably a wet electrostatic precipitator, a relatively high proportion, typically between 95 and 99%, of the finer particulates (generally less than 10 microns in diameter) generated within or downstream from a semiconductor process chamber, or as a by-product from a reaction occurring within the process chamber, can be removed from the gas stream before the gas stream enters the plasma abatement device. Consequently, the plasma abatement device can be exposed to a clean, substantially particulate-free gas stream, allowing more freedom in the design of the plasma abatement device, in particular the diameter of the inlet to the plasma abatement device, to optimise abatement of one or more species of the gas stream.

The gas stream entering the electrostatic precipitator may be at or around atmospheric pressure, or at a sub-atmospheric pressure, for example between 50 and 200 mbar.

The plasma abatement device may be provided with a plurality of inlets each for receiving a respective gas stream, in which case an electrostatic precipitator may be provided upstream from each respective inlet. The individual electrostatic precipitators may be powered from separate power supplies, or they may be powered from a common power supply.

One or more further devices may be located between the, or each, electrostatic precipitator and the plasma abatement device.

An additional electrostatic precipitator may be provided downstream from the plasma abatement device to inhibit the emission from the apparatus of particulates generated within the plasma abatement device, for example during the abatement of silane or other solid-forming gases within the plasma abatement device. Again, one or more further devices may be located between the plasma abatement device and the additional electrostatic precipitator.

The, or each, electrostatic precipitator may be a wet electrostatic precipitator. If a plurality of electrostatic precipitators are provided, a water curtain may be produced in each electrostatic precipitator by a respective separate system, or more preferably by a common system to reduce costs.

In a second aspect, the present invention provides a method of treating a gas stream, the method comprising feeding the gas stream into a plasma abatement device through an inlet thereof, and characterised by, upstream from the abatement device, feeding the gas stream into an electrostatic precipitator to remove particulates from the gas stream thereby to inhibit clogging of the inlet of the abatement device. As discussed above, the gas stream may be subsequently fed into an additional electrostatic precipitator to remove from the gas stream particulates generated within the plasma abatement device.

Features described above in relation to the first aspect of the invention may be equally applied to the second aspect, and vice versa.

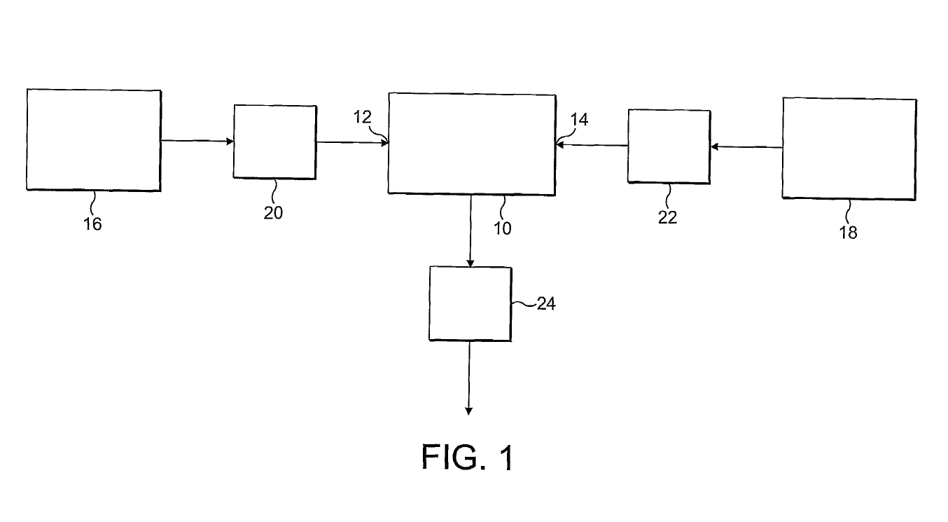

Preferred features of the present invention will now be described, by way of example only, with reference to the accompanying FIG. 1, which illustrates schematically an apparatus for treating a gas stream.

The apparatus comprises a plasma abatement device 10 for abating one or more species of a gas stream. In this example, the abatement device 10 comprises a first inlet 12 and a second inlet 14 each for receiving a gas stream exhaust from a semiconductor or flat panel process chamber 16, 18. However, the abatement device 10 may have any number (one or more) of inlets. Each inlet 12, 14 preferably comprises an aperture having a diameter in the range from 1 to 5 mm.

The abatement device 10 may be provided by any suitable plasma abatement device for abating gases exhaust from a process chamber, for example perfluorocompound cleaning gases such as NF₃, CF₄ and C₂F₆, and unconsumed process gases such as silane (SiH₄) and ammonia (NH₃). One example of a suitable plasma abatement device is a microwave plasma abatement device. In one known microwave plasma abatement technique, the gas stream is conveyed into a microwave resonant cavity within a reactor chamber, the device using microwave radiation to generate a microwave plasma from one or more components of the gas stream. A fluid stream containing a reactant for reacting with the components of the gas stream to be abated may be conveyed to the reactor chamber. For example, when the gas to be abated is a perfluorinated or hydrofluorocarbon compound, for example, one of CF₄, C₂F₆, CHF₃, C₃F₈, C₄F₈, NF₃ and SF₆, a reactant such as H₂ or H₂O may be conveyed into the resonant cavity to form H or OH radicals within the plasma for reacting with the gas to be abated.

Another known technique is to convey the gas stream into a dielectric tube, a high frequency surface-wave exciter being used to produce surface waves that generate a plasma within the tube to dissociate the components of the gas stream. The plasma may be generated using radiation at a frequency of around 915 MHz or 2.45 GHz.

Alternatively, a glow discharge may be generated to decompose these components. As is well known, a glow discharge is a luminous, thermal plasma formed by applying to a gas a voltage that is greater than the breakdown voltage of that gas. The components may be decomposed by a discharge other than a glow discharge, for example by a corona discharge or an arc discharge. Such a discharge may be generated using a dc plasma gun, in which an electric arc is created between a water-cooled nozzle (anode) and a centrally located cathode.

Returning to FIG. 1, an electrostatic precipitator 20, 22 is provided upstream from each inlet 12, 14 of the plasma abatement device 10, that is, between the plasma abatement device 10 and the process chambers 16, 18. The purpose of the electrostatic precipitator is to remove particulates contained within the gas stream passing therethrough before the gas stream enters the plasma abatement device 10.

In this example, each electrostatic precipitator 20, 22 is provided by a wet electrostatic precipitator, although a dry electrostatic precipitator may alternatively be used. The configuration of a wet electrostatic precipitator is generally well known, and so will not be described in detail here. In overview, each wet electrostatic precipitator 20, 22 comprises at least one electrostatic chamber each housing one or more electrodes. A high voltage, typically between 20 and 30 kV, is applied to the electrodes, with the inner wall of the chamber being held at 0 V to generate a corona (an electrostatically charge field) within the chamber. As the gas stream passes through the corona, particulates contained within the gas stream become electrically charged and are attracted towards the chamber wall. In order to prevent the walls from becoming caked with particulates, the chamber wall is continuously washed by recirculated water so that the particulates are washed from the wall into a sump. Waste water containing particulates and any water-soluble gases contained in the gas stream can be subsequently drained from the sump for disposal or further treatment as appropriate.

By optimising the number of electrostatic chambers and the residence time of the gas stream within the electrostatic chambers, the majority, preferably between 95 and 99%, of the particulates contained within the gas stream entering the wet electrostatic precipitator can be removed as the gas stream passes through the electrostatic precipitator, thereby inhibiting clogging of the inlets 12, 14 of the plasma abatement device 10.

As illustrated in FIG. 1, an additional electrostatic precipitator 24 may be provided downstream from the plasma abatement device 10. Similar to the electrostatic precipitators 20, 22, in this example the additional electrostatic precipitator 24 is provided by a wet electrostatic precipitator, although a dry electrostatic precipitator may alternatively be used. The additional wet electrostatic precipitator may have a similar configuration to the electrostatic precipitators 20, 22 provided upstream from the plasma abatement device 10. Abatement of species such as silane within the plasma abatement device 10 can generate solid particulates such as SiO₂, and so the use of an additional electrostatic precipitator downstream from the plasma abatement device 10 can inhibit or minimise the emission of particulates from the apparatus.

1. Apparatus for treating a gas stream comprising
a plasma abatement device having an inlet for receiving the gas stream; and
an electrostatic precipitator positioned upstream from the inlet for removing particulates from the gas stream to inhibit clogging of the inlet of the abatement device.

2. The apparatus according to claim 1 wherein the electrostatic precipitator comprises a wet electrostatic precipitator.

3. The apparatus according to claim 1 wherein the abatement device comprises a plurality of inlets each for receiving a respective gas stream, the apparatus comprising a plurality of said electrostatic precipitators each located upstream from a respective inlet of the plasma abatement device.

4. The apparatus according to claim 1 comprising an additional electrostatic precipitator located downstream from the plasma abatement device.

5. The apparatus according to claim 4 wherein the additional electrostatic precipitator comprises a wet electrostatic precipitator.

6. The apparatus according to claim 1 wherein the plasma abatement device comprises a reactant fluid inlet for receiving a fluid for reacting with a component of the gas stream.

7. The apparatus according to claim 1 wherein the plasma abatement device comprises a microwave plasma abatement device.

8. The apparatus according to claims 1 wherein the plasma abatement device comprises a dc plasma torch.

9. The apparatus according to claim 1 wherein the inlet comprises an aperture having a diameter in the range from 1 to 5 mm.

10. A method of treating a gas stream, the method comprising feeding the gas stream into a plasma abatement device through an inlet thereof, and characterised by, upstream from the abatement device, feeding the gas stream into an electrostatic precipitator to remove particulates from the gas stream thereby to inhibit clogging of the inlet of the abatement device.

11. The method according to claim 10 comprising the step of feeding the gas stream into an additional electrostatic precipitator to remove from the gas stream particulates generated within the plasma abatement device.

12. The method according to claim 10 comprising the step of conveying to the abatement device a fluid for reacting with a component of the gas stream.

13. The apparatus according to claim 3 wherein each inlet comprises an aperture having a diameter in the range from 1 to 5 mm.
